(19) United States
(12) Patent Application Publication
(10) Pub. No.: US 2011/0308120 A1
(43) Pub. Date: Dec. 22, 2011

(54) LED ASSEMBLY HAVING IMPROVED VISIBILITY, ITS ATTACHING METHOD AND BANNER USING IT

(76) Inventor: Jae Yong Heo, Seoul (KR)

(21) Appl. No.: 13/148,914

(22) PCT Filed: Feb. 11, 2010
(86) PCT No.: PCT/KR10/00889

§ 371 Date: Aug. 10, 2011

(30) Foreign Application Priority Data
Feb. 11, 2009 (KR) 10-2009-0010937
Mar. 26, 2009 (KR) 10-2009-0025672

(51) Int. Cl. G09F 13/00; F21V 11/00; F21S 8/00

(52) U.S. Cl. 40/541; 362/311.02; 362/237

(57) ABSTRACT

The present invention relates to an LED assembly and a banner using the same. In particular, the present invention relates to an LED assembly, an attaching method of the same, and a banner using the same to prevent light from scattering by covering an LED with a light-permeable part which comprises light-permeable thin and thick films and to limit light emission range to the size of the light-permeable part, wherein the light-permeable thin film transmits light a long distance and also releases intense light directly in front of the front side of the LED, and the light-permeable thick film transmits the light laterally by reflecting a part of the light, which passes through a medium, inside, because the medium is thick, thereby improving shapability and visibility from a long distance to a short distance.

### TECHNICAL FIELD

The present invention relates to an LED assembly and a banner using the same. In particular, the present invention relates to an LED assembly for preventing light from scattering and limiting light emission range to the size of a light-permeable part by covering an LED with the light-permeable part which comprises light-permeable thin and thick parts, wherein the light-permeable thin part transmits light a long distance and also eases the glare of intense light directly in front of the front side of the LED, and the light-permeable thick film transmits the light laterally by reflecting a part of the light, which passes through a thick medium, thereby improving shapability and visibility from a long distance to a short distance.

### BACKGROUND ART

Light emitting diodes (LEDs) are variously applied to various kinds of devices such as electronic products, electronic display boards and indicators. However, since such an LED emits light forward, the glare of intense light occurs due to high brightness when a user views the LED just in front of the LED. Therefore, user's eyes are easily fatigued. If characters are made through combination of such LEDs, it is difficult to exactly recognize the characters just in front of the LEDs to the glare of intense light. Since light emitted from the LED has a property of advancing straight, the light is hardly emitted from sides of the LED, and therefore, it is not easy to recognize the light from the sides of the LED.

Accordingly, in a case where characters are expressed through combination of several LEDs, user's eyes are easily fatigued just in front of the front side of the LEDs due to the glare of intense light, and it is difficult to recognize the shapes of light-permeable parts of the LEDs. Further, since light emitted from the LEDs is not properly emitted from sides of the LEDs, it is not easy to recognize the shapes of the light-permeable parts of the LEDs. Therefore, it may be difficult to entirely recognize the characters.

In a conventional light emitting device using an LED, the range of light emitted from one LED is relatively narrow because of the front emission of the LED and the straightness of light emitted from the LED, and therefore, visibility at long and short distances is improved using a plurality of LEDs. However, since the plurality of LEDs should be mounted in the light emitting device, the circuit configuration is complicated, and installation and material costs are increased. Further, it is difficult to perform maintenance and repair.

Meanwhile, banners are used as a type of advertisement by recording a name, products for sale, categories of business, contents of public relations, etc. on a textile, sheet, film, etc. in a shop, company, business office, institution, etc. and then hanging or attaching the textile, sheet, film, etc. indoors or outdoors so as to be well viewed by people. The banners are a kind of advertisements, which are frequently used regardless of the East and the West. Various materials of the banners have been changed and developed, but there is no case where a light source is inserted into a banner.

Therefore, since the function of the banner is limited at night, it is required to develop a banner into which a light source is inserted using a new technique so as to maximize its public relations effect at night as well as daytime.

### DISCLOSURE OF INVENTION

### Technical Problem

Accordingly, an object of the present invention is to provide an LED assembly for preventing light from scattering and limiting light emission range to the size of a light-permeable part by covering an LED with the light-permeable part which comprises light-permeable thin and thick parts, wherein the light-permeable thin part transmits light a long distance and also eases the glare of intense light directly in front of the front side of the LED, and the light-permeable thick film transmits the light laterally by reflecting a part of the light, which passes through a thick medium, thereby improving shapability and visibility from a long distance to a short distance.

Another object of the present invention is to provide a banner for maximizing its advertisement and public relations effect by improving visibility of the banner at long/short distances and front/sides.

### Technical Solution

According to an aspect of the present invention, there is provided an LED assembly with improved visibility and shapability, the LED assembly comprising: at least one LED; a light-permeable part configured to surround an emission part of the LED, transmit light of the LED to an outside thereof, and have a flat bottom surface; and a fixing part positioned on a bottom surface of the LED, wherein the light-permeable part comprises at least one light-permeable thin part of which thickness is thin in the light-permeable part so as to ease the glare of intense light just in front of the LED and to improve visibility at a long distance, and at least one light-permeable thick part of which thickness is thicker than that of the light-permeable thin part in the light permeable part so as to emit the light to sides of the LED by widely diffusing the light of the LED.

The light-permeable thin or thick part may have the shape of a figure, number or character.

A barrier for surrounding the LED may be mounted to the fixing part, and the light-permeable part may be joined with the barrier.

The light-permeable part and the LED may be separated from each other.

A reflection plate may be mounted to a lower part of the light-permeable part.

The light-permeable thin part may have a thickness of 0.1 to 10 mm, and the light-permeable thick part may have a thickness 1.5 to 20 times thicker than the thickness of the light-permeable part.

According to an aspect of the present invention, there is provided an LED assembly with improved visibility and shapability, the LED assembly comprising: at least one LED; a support platform positioned on a bottom surface of the LED; a light-permeable part configured to surround the LED and the support platform, transmit light of the LED to an outside thereof, and have a flat bottom surface, the light-permeable part comprising at least one light-permeable thin part of which thickness is thin in the light-permeable part so as to ease the glare of intense light just in front of the LED and to improve visibility at a long distance, and at least one light-permeable thick part of which thickness is thicker than that of the light-permeable thin part in the light permeable part so as to emit the light to sides of the LED by widely diffusing the light of the LED; and a fixing part positioned on a bottom surface of the support platform.

According to an aspect of the present invention, there is provided an LED assembly with improved visibility and shapability, the LED assembly comprising: at least one LED; a sidewall of which inside and outside come in contact with sides of the LED and a fixture, respectively; a light-permeable part connected to the sidewall, the light-permeable part surrounding an emission part of the LED and transmitting light of the LED to an outside thereof, the light-permeable part comprising at least one light-permeable thin part of which thickness is thin in the light-permeable part so as to ease the glare of intense light just in front of the LED and to improve visibility at a long distance, and at least one light-permeable thick part of which thickness is thicker than that of the light-permeable thin part in the light permeable part so as to emit the light to sides of the LED by widely diffusing the light of the LED; and a fixing part positioned beneath the LED.

According to an aspect of the present invention, there is provided an LED assembly with improved visibility and shapability, the LED assembly comprising: at least one LED; a support platform positioned on a bottom surface of the LED; a sidewall of which inside and outside come in contact with the support platform and a fixture, respectively; a light-permeable part connected to the sidewall, the light-permeable part surrounding an emission part of the LED and transmitting light of the LED to an outside thereof, the light-permeable part comprising at least one light-permeable thin part of which thickness is thin in the light-permeable part so as to ease the glare of intense light just in front of the LED and to improve visibility at a long distance, and at least one light-permeable thick part of which thickness is thicker than that of the light-permeable thin part in the light permeable part so as to emit the light to sides of the LED by widely diffusing the light of the LED; and a fixing part positioned beneath of the LED, the fixing part having a PCB formed therein.

According to an aspect of the present invention, there is provided an LED assembly with improved visibility and shapability, the LED assembly comprising: two LEDs respectively attached to both sides of a fixing part about the fixing part; and two light-permeable parts configured to surround the respective LEDs, transmit light of the respective LEDs to outsides thereof, and each have a flat bottom surface, wherein each of the light-permeable part comprises at least one light-permeable thin part of which thickness is thin in the light-permeable part so as to ease the glare of intense light just in front of the LED and to improve visibility at a long distance, and at least one light-permeable thick part of which thickness is thicker than that of the light-permeable thin part in the light permeable part so as to emit the light to sides of the LED by widely diffusing the light of the LED.

According to an aspect of the present invention, there is provided an LED assembly with improved visibility and shapability, the LED assembly comprising a plurality of LED assemblies configured to represent a character or figure through a combination thereof, wherein each of the LED assemblies comprises at least one LED; a light-permeable part configured to surround an emission part of the LED, transmit light of the LED to an outside thereof, and have a flat bottom surface; and a fixing part positioned on a bottom surface of the LED, wherein the light-permeable part comprises at least one light-permeable thin part of which thickness is thin in the light-permeable part so as to ease the glare of intense light just in front of the LED and to improve visibility at a long distance, and at least one light-permeable thick part of which thickness is thicker than that of the light-permeable thin part in the light permeable part so as to emit the light to sides of the LED by widely diffusing the light of the LED.

A light diffusion part for surrounding the LED may be formed at an outside of the LED. A lower portion of the light diffusion part may be fixed to the fixing part. The light diffusion part has may be formed above the LED while forming a thin wall along the side of the LED from the bottom of the fixing part

According to an aspect of the present invention, there is provided an attaching method of the LED assembly, wherein the fixing part is attached to the fixture using a high-frequency attaching method.

According to an aspect of the present invention, there is provided an attaching method of the LED assembly, wherein the fixing part is attached to the fixture by joining the light-permeable part with the fixing part above the fixture in the state that the fixing part is inserted into an insertion hole of the fixture.

According to an aspect of the present invention, there is provided a banner using LED assemblies with improved visibility and shapability, the banner comprising: a display part in which contents intended to communicate are displayed; the aforementioned plurality of LED assemblies attached at a predetermined interval in the display part; a control part configured to control the LED assemblies; and a power supply part configured to supply power to the LED assemblies.

The display part may be made of a material restorable even when the display part is rolled or crumpled.

The display part may be formed by joining two display parts together so that contents intended to communicate by the two display parts face outsides opposite to each other.

An auxiliary part for surrounding electric wires of the LED assemblies may be attached to a rear side of the display part.

### ADVANTAGEOUS EFFECTS

In the LED assembly with improved visibility and shapability according to the present invention, although one LED consuming the same power is used, light emitted from the LED can be easily recognized not only at a long distance but also at the front and sides of the LED at a short distance, as compared with the conventional LED assembly. Thus, it is possible to improve the visibility and shapability of the LED assembly. Particularly, it is possible to ease the glare of intense light just in front of the front side of the LED and to easily recognize the light of the LED.

Accordingly, if characters or figures are made by combining the LED assemblies according to the present invention, the contents of the characters or figures can be easily recognized not only at a long distance but also at the front and sides of the LED.

Since light with various colors can be expressed with only one LED assembly by allowing the color of light of an LED and the color of a light-permeable part to be identical to or different from each other or by allowing the thicknesses of light-permeable thin and thick parts to be different from each other, the advertisement effect is remarkable when the LED assembly is used for a signboard.

Since the range of light emitted to the front and sides of an LED is broadened, the LED assembly according to the present invention can obtain the same effect as the conventional LED assembly, while using a smaller number of LEDs. Thus, as the LED assembly according to the present invention uses a smaller number of LEDs than the conventional LED assembly so as to emit light in the same range, the power consumption of the LED assembly according to the present invention is relatively smaller than that of the conventional LED assembly, thereby obtaining high electrical efficiency.

In the banner with improved visibility according to the present invention, LED assemblies are attached to the banner as light emitting means for emphasizing contents printed in the banner, and thus, the banner can attract people's sight as compared with other banners. Particularly, while the other banners do not their functions at night, the banner according to the present invention attracts people's sight using LED assemblies with various colors and shapes, thereby obtaining remarkable advertisement and public relations effects.

Further, the banner according to the present invention uses LED assemblies each having light-permeable thin and thick parts, so that it is possible to improve the visibility at long/short distances and front/sides of an LED, as compared with the conventional banner. Particularly, it is possible to ease the glare of intense light in front of the front side of the LED and to easily recognize the light of the LED.

Thus, if characters or figures are made by combining the LED assemblies according to the present invention, it is possible to easily recognize the contents of the characters or figures not only at a long distance but also at the front and sides of the LED. Accordingly, it is possible to rapidly and exactly inform people of the contents intended to communicate using the banner, thereby obtaining remarkable advertisement and public relations effects.

### BRIEF DESCRIPTION OF DRAWINGS

FIG. 1 is a schematic view of a first embodiment of an LED assembly with improved visibility and shapability according to the present invention.

FIG. 2 is a schematic view of the LED assembly with improved visibility and shapability when the emission part of an LED is short according to the present invention.

FIG. 3 is a perspective view of a tetrahedral light-permeable part having a flat light-permeable thin part and a convex light-permeable thick part.

FIG. 4 is a view showing states that a light-permeable thin part is engraved.

FIG. 5 is a view showing states that a light-permeable thick part is embossed.

FIG. 6 is an exemplary view of the LED assembly having a plurality of light-permeable thin and thick parts.

FIG. 7 is a sectional view of the LED assembly having an embodiment of a fixing part according to the present invention.

FIG. 8 is a schematic view showing a modification of the first embodiment according to the present invention.

FIG. 9 is a view showing the LED assembly attached to a fixture according to the present invention.

FIG. 10 is a view showing the LED assembly inserted into an insertion hole and attached to the fixture according to the present invention.

FIG. 11 is a sectional view of the LED assembly having two air exhausting grooves formed therein.

FIG. 12 is a sectional view taken along line A-A of FIG. 11.

FIG. 13 is a sectional view of the LED assembly having an embossing formed therein.

FIG. 14 is a schematic view of a second embodiment of the LED assembly with improved visibility and shapability according to the present invention.

FIG. 15 is a schematic view showing a modification of the second embodiment of the present invention.

FIG. 16 is a schematic view of a third embodiment of the LED assembly with improved visibility and shapability according to the present invention.

FIG. 17 is a schematic view of a fourth embodiment of the LED assembly with improved visibility and shapability according to the present invention.

FIG. 18 is a schematic view of an LED assembly having an attachment part mounted thereto as a fifth embodiment of the LED assembly according to the present invention.

FIG. 19 is a schematic view of an LED assembly having a light diffusion part mounted thereto as a sixth embodiment of the LED assembly according to the present invention.

FIG. 20 is a schematic view of a seventh embodiment of the LED assembly with improved visibility and shapability according to the present invention.

FIG. 21 is a schematic view of a banner mounted to a mounting platform as an embodiment of the banner according to the present invention.

FIG. 22 is a schematic view of a banner for displaying the position of a product, mounted to an upper part of a shop, as an embodiment of the banner according to the present invention.

FIG. 23 is a schematic view of a banner mounted at an entrance of a shop as an embodiment of the banner according to the present invention.

FIG. 24 is a schematic view of a placard banner as an embodiment of the banner according to the present invention.

FIG. 25 is a schematic view of a banner mounted to window as an embodiment of the banner according to the present invention.

FIG. 26 is a schematic view of a banner using a person as an embodiment of the banner according to the present invention.

### MODE FOR INVENTION

The present invention now will be described more fully hereinafter with reference to the accompanying drawings, in which embodiments of the invention are shown. This invention should not be construed as limited to the embodiments set forth herein. Rather, these embodiments are provided so that this disclosure will be thorough and complete, and will fully convey the scope of the invention to those skilled in the art.

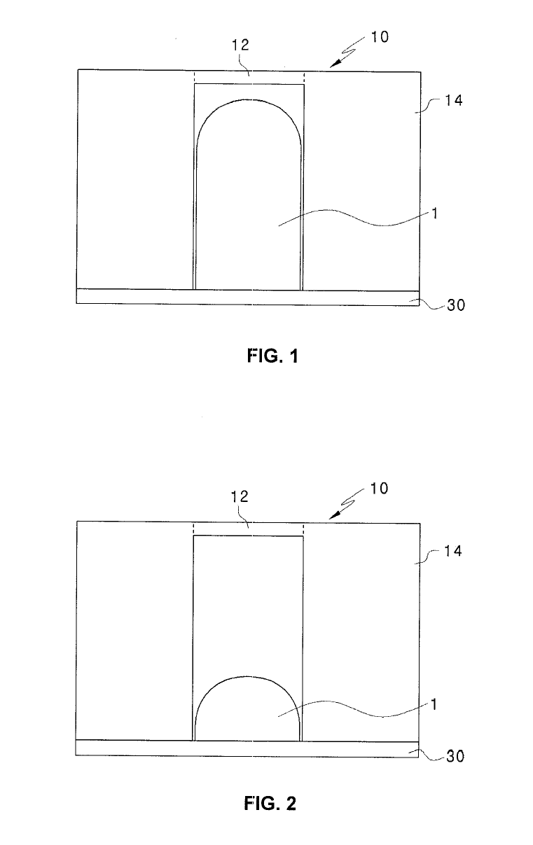

FIG. 1 is a schematic view of a first embodiment of an LED assembly with improved visibility and shapability according to the present invention. As shown in FIG. 1, the LED assembly with improved visibility and shapability according to the present invention comprises an LED 1, a light-permeable part 10 and a fixing part 30.

The shape of the LED used in the present invention is not particularly limited. For example, the emission part of the LED may be long as shown in FIG. 1, and the emission part of the LED may be short as shown in FIG. 2. In a case where the emission part of the LED is short as shown in FIG. 2, the brightness at sides of the LED may be more intense as compared with FIG. 1. Further, in a case where the emission part of the LED is short as shown in FIG. 2, the shape of the light-permeable part may be changed depending on the shape of the emission part of the LED. In addition, it will be apparent that an LED of which emission part has a short but wide shape and an LED having a round shape may be applied to the present invention.

The number of LEDs used in the present invention is at least one. Here, the number of LEDs is not particularly limited. In a case where a plurality of LEDs are mounted in the LED assembly, the LEDs having different colors may be mounted in the LED assembly. Further, the LEDs may be mounted at different angles from one another in the LED assembly. This is provided to improve visibility at various angles in consideration of the straightness of light emitted from the LEDs.

The light-permeable part 10 surrounds the emission part of the LED 1 and transmits light of the LED 1 to the outside thereof. The light-permeable part has a flat bottom surface. The light-permeable part 10 prevents light from scattering and limits light emission range to the size of the light-permeable part, so as to increase the degree of concentration of light, to reflect various expressions of light according to the shape of the light-permeable part, and to enable several colors, shapes and brightnesses to be expressed in one LED assembly. Since the light-permeable part 10 surrounds the emission part of the LED 1, the light-permeable part functions to protect the LED 1 from an external impact applied to the LED1. Light emitted from the LED 1 is emitted to the outside of the LED assembly through the light-permeable part 10. While passing through the light-permeable part 10, the light is reflected, diffracted and the like. In the present invention, the light-permeable part 10 is composed of at least one light-permeable thin part 12 and at least one light-permeable thick part 14.

The light-permeable thin part 12 is a thin part of the light permeable part so as to cast the light of the LED 1 up to a long distance, particularly to ease the glare of intense light just in front of the LED. The light-permeable thick part 14 is a part thicker than the light-permeable thin part 12 in the light-permeable part so as to highlight the shape of the light-permeable part by widely spreading the light of the LED 1 so that light is easily recognized even at sides of the LED 1. In the light-permeable thin part 12, the thickness of a medium through which the light of LED 1 passes is thin, and therefore, almost of the light passes through the light-permeable thin part without loss of energy. Thus, people at a relatively long distance can recognize the light emitted from the light-permeable thin part 12. Further, a thin film exists in the light-permeable thin part 12, and therefore, it is possible to ease the glare of intense light just in front of the front side of the LED.

The thickness of the light-permeable thin part 12 is changed depending on the brightness of the LED mounted in the LED assembly. In a general LED, the thickness of the LED is preferably 0.1 to 10 mm. If the thickness of the LED is less than 0.1 mm, the glare of intense light occurs just in front of the LED. If the thickness of the LED exceeds 10 mm, it is difficult to case light of the LED up to a long distance because the light is interrupted by the light-permeable part.

The light-permeable thin part 12 casts light to a long distance and ease the glare of intense light just in front of the LED, thereby improving the entire visibility of the LED assembly.

The light-permeable thin part 12 may be formed by making a hole in the inside of the light-permeable part 10 so that the light-permeable part with the hole is thinner than its surroundings or by forming a part from which light is intensely emitted on the outer surface of the light-permeable part to be thinner than its surroundings.

In FIG. 1, the light-permeable thin part 12 has a flat shape when being viewed from a side of the light-permeable thin part. However, the light-permeable thin part may have a convex shape in which light can be diffused or a concave shape in which light can be gathered.

The light-permeable thick part 14 is a part thicker than the light-permeable thin part 12 in the light-permeable part. Since a medium of the light-permeable thick part is thick, a part of the light passing through the medium is reflected in the inside of the light-permeable thick part so that the light is spread throughout the entire of the light-permeable thick part 14 and emitted to the outside of the light-permeable part. Thus, the light emitted from the light-permeable part 14 is darker than that emitted from the light-permeable thin part 12, but is entirely spread, so that it is possible to recognize the shape of the light-permeable part not only in front of the front side of the LED 1 but also at sides of the LED 1.

As a result, the light emitted from the light-permeable thin part 12 is casted in a direction of the front side of the LED 1 up to a long distance, so that it is possible to enable people at the long distance to easily recognize the light and to ease the glare of intense light just in front of the front side of the LED. Accordingly, it is possible to recognize the light of the LED 1 at a short distance, particularly just in front of the LED, without the fatigue of eyes. The light emitted from the light-permeable part 14 is also emitted to the sides of the LED 1, so that people can easily recognize the shape of the light-permeable part event at the sides of the LED 1, thereby improving the shapability of the LED assembly. The light emitted from the light-permeable thin part 12 is bright, and the light emitted from the light-permeable thick part 14 is gentle so that the light-permeable thin and thick parts 12 and 14 are harmonized, thereby obtaining a remarkable visual effect.

The thickness of the light-permeable thick part 14 is not particularly limited. However, the light-permeable thick part is preferably 1.5 to 20 times thicker than the light-permeable thin part 12 so that light is emitted to the sides of the LED. If the thickness of the light-permeable thick part exceeds 20 times, the amount of the light emitted to the outside is too small.

The position of each of the light-permeable thin and thick parts 12 and 14 is not particularly limited. However, the light-permeable thin part 12 is preferably formed at the front side that is a direction in which the light of LED 1 is most intensely emitted, in consideration of the straightness of light, so that the light emitted from the light-permeable thin part is casted up to a long distance. The light-permeable thick part 14 is preferably mounted around the light-permeable thin part 12.

The number of each of the light-permeable thin and thick parts 12 and 14 is not particularly limited, and several light-permeable thin and thick parts 12 and 14 may be formed as occasion demands.

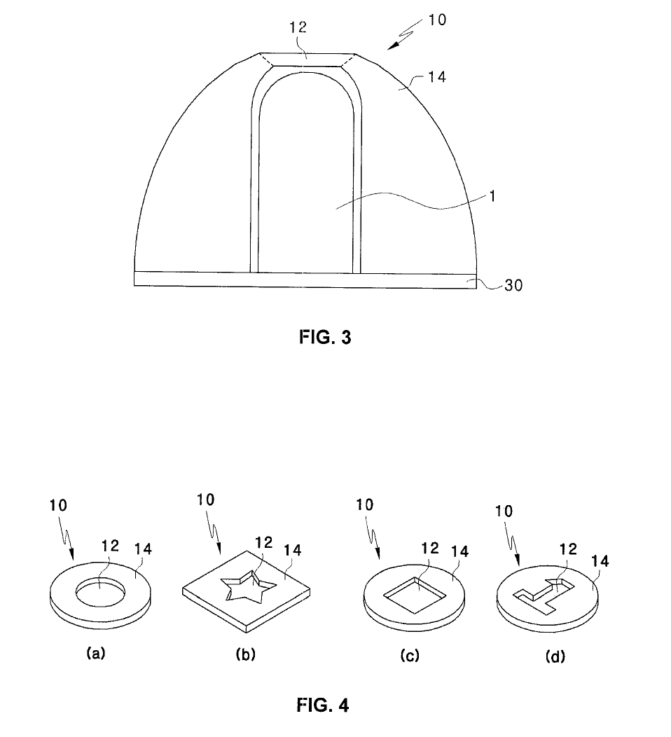

The entire shape of the light-permeable part 10 is not particularly limited. In FIG. 1, the light-permeable part has a tetrahedral shape, but may have various three-dimensional shapes such as trihedral, pentahedral, hexahedral and hemispheric shapes. FIG. 3 shows light-permeable parts having a hemispheric shape as an example of various three-dimensional shapes. When a top part of the light-permeable part 10 comes in contact with glass or plastic, the top part of the light-permeable part may be formed flat as shown in FIG. 1 or 2 so as to increase its adhesion with the glass or plastic.

The shape of each of the light-permeable thin and thick parts 12 and 14 when being viewed from the top is not particularly limited. The shape of each of the light-permeable thin and thick parts is generally a circle, but may be the shape of a specific figure or character including a star, a triangle, a square, an animal pattern, a person's figure, a character pattern, and the like. In this case, the shape of a figure or character formed in the light-permeable thin or thick part 12 or 14 can be recognized from the outside.

Since the light-permeable thin part 12 means a part of which thickness is relatively thinner than the other part in the light-permeable part, the light-permeable thin part 12 may be implemented by forming the light-permeable part and then engraving a part corresponding to the light-permeable thin part 12 in the light permeable part. FIG. 4 is a view showing states that the light-permeable thin part 12 is engraved. As shown in (a) to (d) of FIG. 4, the light-permeable thin part 12 is a part engraved in the light-permeable part, and the other part except the engraved part is the light-permeable thick part 14.

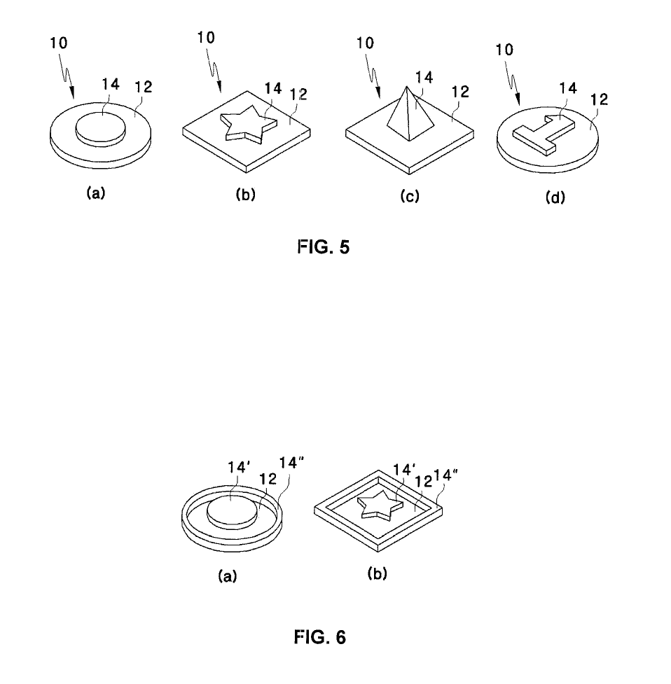

Since the light-permeable thick part 14 means a part of which thickness is relatively thicker than the other part in the light-permeable part, the light-permeable thick part 14 may be implemented by forming the light-permeable part and then embossing a part corresponding to the light-permeable thick part 14 in the light-permeable part. FIG. 5 is a view showing states that the light-permeable thick part 14 is embossed. As shown in (a) to (d) of FIG. 5, the light-permeable thick part 14 is a part embossed in the light-permeable part, and the other part except the embossed part is the light-permeable thin part 12. In FIG. 4, the light-permeable thick part 14 is positioned at the center of the light-permeable part, and the light-permeable thin part 12 is positioned around the center of the light-permeable part.

Several light-permeable thin and thick parts 12 and 14 may exist in the light-permeable part through combination of embossing and engraving. FIG. 6 is an exemplary view of the LED assembly having a plurality of light-permeable thin and thick parts 12 and 14. As shown in (a) and (b) of FIG. 6, there exist an embossed light-permeable thick part 14′ positioned at the center of the light-permeable part, another light-permeable thick part 14″ positioned at an edge of the light-permeable part, and a light-permeable thin part 12 engraved between the light-permeable thick parts. Thus, when viewing the light-permeable part from the outside, the light-permeable thin part 12 between the central circle 14′ and the edge circle 14″ is shown brightest in (a) of FIG. 6, and the light-permeable thin part 12 between the central star 14′ and the edge star 14″ is shown brightest in (b) of FIG. 6. FIGS. 4 to 6 show only flat parts at the upper part of the light-permeable part.

The light-permeable thin or thick part 12 or 14 may be coated with a color so as to emphasize the visible effect of the LED assembly. Here, the light-permeable thin and thick parts 12 and 14 may be coated with the same color or different colors. The light-permeable thin and thick parts 12 and 14 may be simultaneously coated with several colors. Only the outer parts of the light-permeable thin and thick parts 12 and 14 may be coated with a color. Light emitted from one LED may be variously expressed by allowing the colors of the LED and the light-permeable part to be identical to or different from each other.

The material of the light-permeable part 10 is not particularly limited, and may be a modable and permeable material. For example, the material of the light-permeable part may be glass, plastic, silicon, latex, rubber, urethane, resin, epoxy resin, polycarbonate, polymer, or the like. Among these materials, the silicon with excellent moldability or the polycarbonate with excellent light diffusion is most preferably used.

The fixing part 30 is a part positioned at the bottom of the LED 1 and the light-permeable part 10. The fixing part is a part that comes in contact with a fixture when the LED assembly according to the present invention is attached to another object. As occasion demands, a PCB substrate may be positioned on the fixing part, or may be included in the inside of the fixing part. The fixing part is a part that serves as a support for protecting the LED assembly according to the present invention.

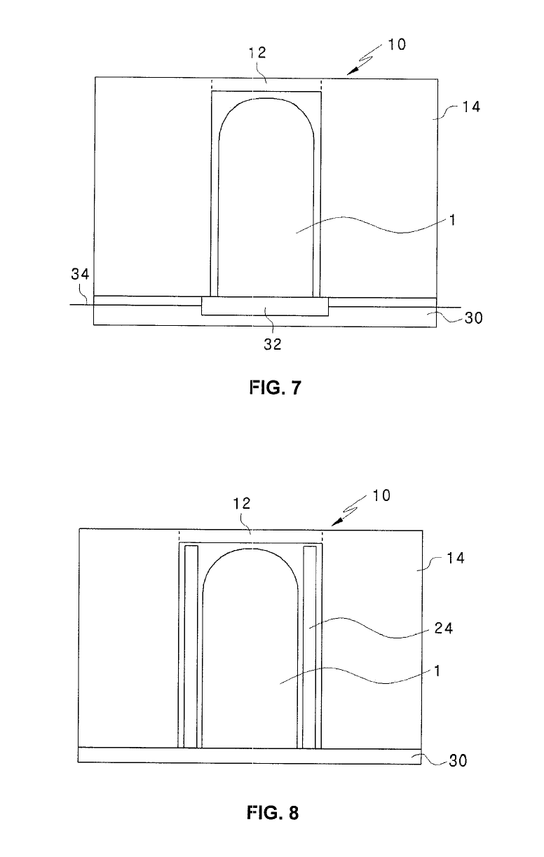

FIG. 7 is a sectional view of the LED assembly having an embodiment of the fixing part according to the present invention. As shown in FIG. 7, the fixing part 30 comprises not only a PCB substrate 32 formed in the inside thereof but also a wire 34 connected to the PCB substrate 32. The fixing part is formed thick so that only the wire 34 is connected to the fixing part at the outside of the fixing part. Accordingly, the LED assembly according to the present invention can considerably reduce connection failure or damage of the PCB substrate or the wire.

Meanwhile, when the LED assembly is used outdoors, a rubber ring may be inserted between the fixing part 30 and the light-permeable part 10 for the purpose of waterproof processing.

FIG. 8 is a schematic view showing a modification of the first embodiment according to the present invention. As shown in FIG. 8, in the modification of the first embodiment, a barrier wall 24 surrounds the LED 1, and the light-permeable part 10 is joined with the barrier wall 24. The barrier wall 24 protects the LED from an external impact and allows the light-permeable part 10 to be joined therewith.

The diameter of a support platform 20 is greater than that of the LED 1, and a protection wall 22 for protecting the LED 1 from surroundings of the LED 1 may be mounted to the support platform 20. The protection wall 22 is formed in a circular shape around the LED 1 so as to prevent the LED 1 from being easily damaged when the LED assembly with improved visibility and shapability according to the present invention is used at a part, such as a floor, at which the LED 1 may be easily damaged. Here, the protection wall 22 unnecessarily surrounds all the surroundings of the LED 1.

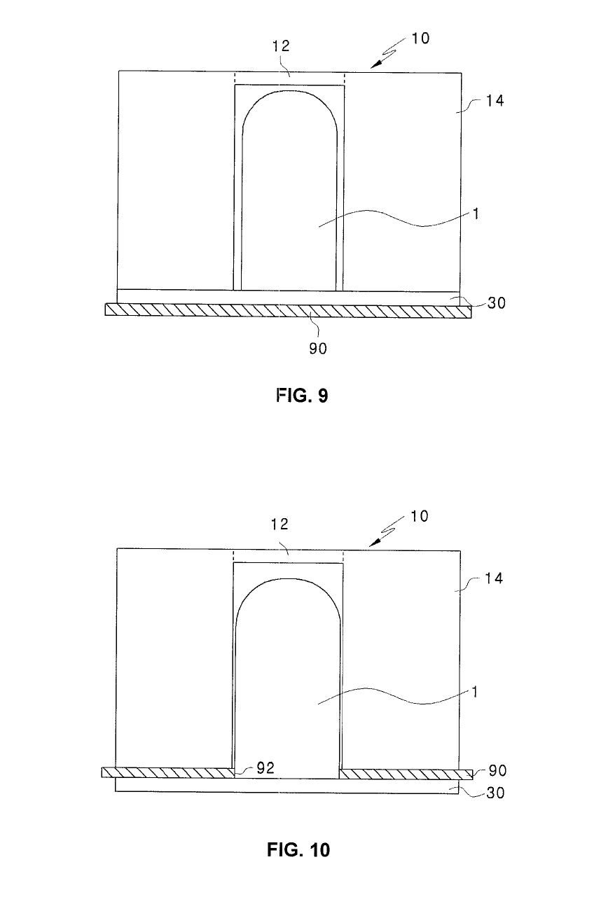

The LED assembly according to the present invention may be entirely formed in a single body. However, the LED assembly may be formed so that the light-permeable part 10 and the LED part (the LED and the fixing part) are separated from each other. In a case where the LED assembly according to the present invention is entirely formed in a single body, the LED assembly is attached to a fixture 90 as shown in FIG. 9. Here, the attaching method is not particularly limited, but a high-frequency attaching method is most preferably used in consideration of the convenience of a working process, and the like.

In a case where the light-permeable part 10 and the LED part are separated from each other, the light-permeable part and the LED part may be joined with each other using a rear or front insertion method, as shown in FIG. 10. In the rear insertion method, the light-permeable part 10 is disposed on an insertion hole 92, and the LED part and light-permeable part are joined with each other by pushing, the LED part from the lower part of the insertion hole 92 so that the LED part is inserted into the light-permeable part from the lower part to the upper part of the light-permeable part through the insertion hole. In the front insertion method, the LED part and the light-permeable part 10 are joined with each other by inserting the LED part into the insertion hole from the lower part to the upper part of the insertion hole and then pushing the light-permeable part at the upper part of the insertion hole 92 so that the LED part is inserted into the light-permeable part. Thus, the replacement of the LED can be easily performed. In this case, the light-permeable part 10 is fixed by being adhered closely to the LED or by being adhered closely to an external barrier wall.

In a case where the LED part and the light-permeable part 10 separated from each other are fixed to the fixture 90 using the rear or front insertion method, the LED part and the light-permeable part 10 may be separated from each other in the long-term use of the LED assembly because air in an inside 100 of the light-permeable part 10 into which of the LED part is inserted is compressed in the process of inserting the LED part into the light-permeable part 10. In the present invention, to solve such a problem, an air exhaustion means may be formed in the inside 100 of the light-permeable part.

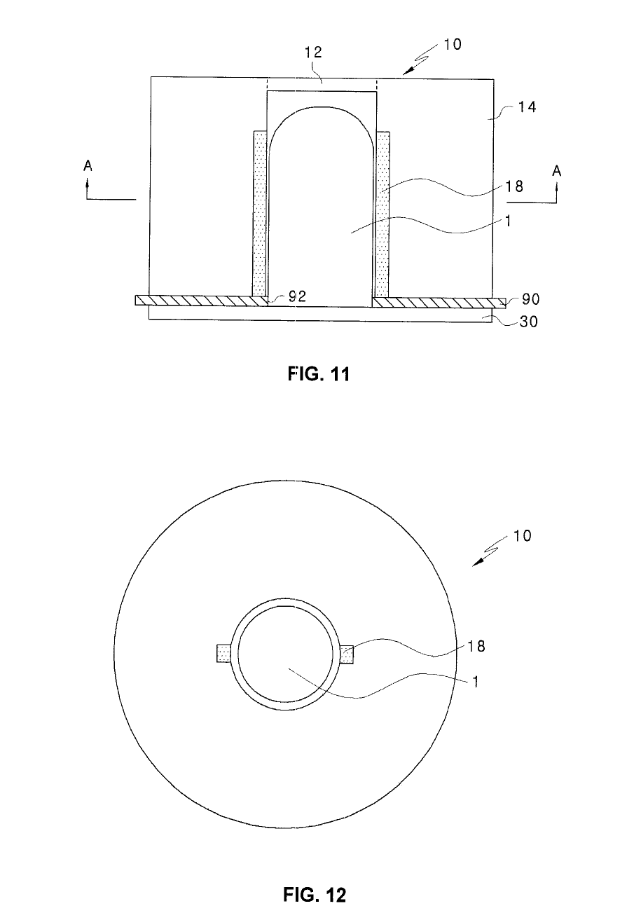

In the present invention, the air exhaustion means may be an air exhaustion groove 18 or embossing 19. FIG. 11 is a sectional view of the LED assembly having two air exhausting grooves formed therein. FIG. 112 is a sectional view taken along line A-A of FIG.

11. As shown in FIG. 11, at least one groove is formed in the insertion direction of the LED 1 at a part at which the inside of the light-permeable part 10 comes in contact with the LED 1. The air exhaustion groove 18 allows the air in the inside of the light-permeable part 10 to be exhausted to the outside in the process of inserting the LED 1 into the light-permeable part.

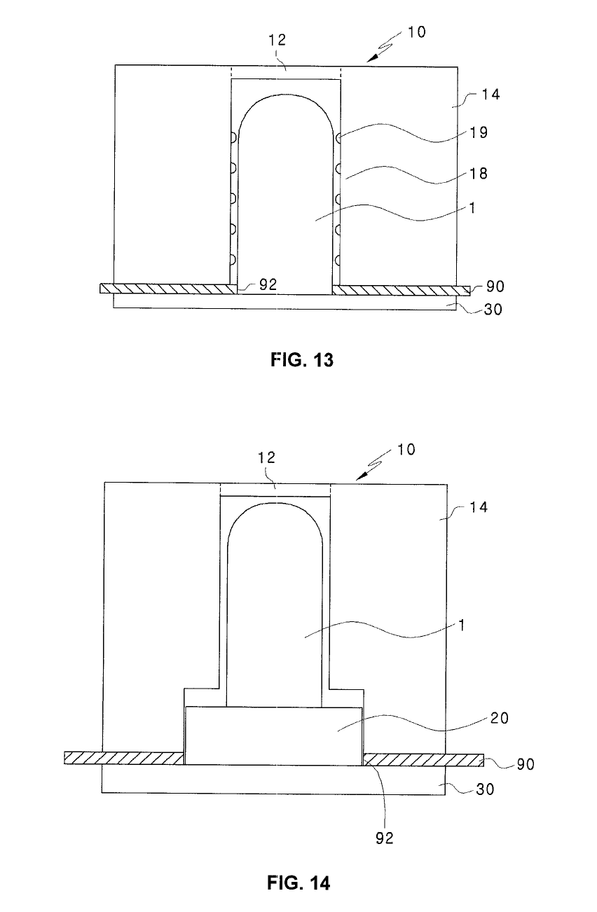

FIG. 13 is a sectional view of the LED assembly having an embossing formed therein. As shown in FIG. 13, at least one embossing is formed at the part at which the inside of the light-permeable part 10 comes in contact with the LED 1. In the process of inserting the LED 1 into the light-permeable part, the air in the inside of the light-permeable part 10 is exhausted to the outside through a space between the embossings 19 so as to prevent excessive compressed air from being formed in the inside of the light-permeable part.

Here, the air exhaustion groove 18 or embossing 19 may be formed not only at the side of the LED but also at the side of the support platform as occasion demands.

FIG. 14 is a schematic view of a second embodiment of the LED assembly with improved visibility and shapability according to the present invention. As shown in FIG. 14, the LED assembly according to the second embodiment of the present invention comprises an LED 1, a support platform 20, a light-permeable part 10 and a fixing part 30. In the second embodiment, the support platform 20 is different from that in the first embodiment, and therefore, the support platform will be described in detail.

The support platform 20 is a part positioned beneath the LED 1 so as to support the

LED 1. A side of the support platform 20 comes in contact with the fixture 90 to which the LED assembly with improved visibility and shapability according to the present invention is fixed. The support platform 20 is a part completely adhered closely to the light-permeable part 10 so as to allow the LED 1 to be completely fixed in the inside of the light-permeable part 10 and to prevent damage caused by vibration of the LED 1. The LED assembly according to the second embodiment may be entirely formed in a single body, but the light-permeable part 10 and the LED part (the LED, the fixing part and the support platform) may be separated from each other. In a case where the LED assembly is entirely formed in a single body, the fixing part 30 of the LED assembly is inserted into an insertion hole 92 of the fixture 90. In a case where the light-permeable part 10 and the LED part are separated from each other, the light-permeable part 10 is disposed on the insertion hole 92, and the LED part and the light-permeable part 10 are joined with each other by inserting the LED part into the light-permeable part from the lower part to the upper part of the light-permeable part through the insertion hole. Thus, the fixture 90 comes in contact with the support platform. Here, a screw thread is formed at the side of the support platform 20 and the side of the inside of the light-permeable part 10 that comes in contact with the support platform, so that the support platform and the light-permeable part can be easily and firmly joined with each other. In addition to the screw thread, a joining means such as a hook may be used.

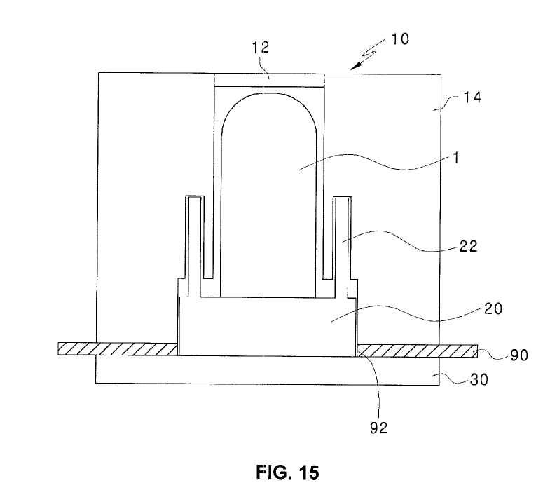

FIG. 15 is a schematic view showing a modification of the second embodiment of the present invention. As shown in FIG. 15, the diameter of the support platform 20 is greater than that of the LED 1, and a protection wall 22 for protecting the LED 1 from the surroundings of the LED 1 may be mounted to the support platform 20. The protection wall 22 is formed in a circular shape around the LED 1 so as to prevent the LED 1 from being easily damaged when the LED assembly with improved visibility and shapability according to the present invention is used at a part, such as a floor, at which the LED 1 may be easily damaged. Here, the protection wall 22 unnecessarily surrounds all the surroundings of the LED 1. Here, the protection wall 22 unnecessarily surrounds all the surroundings of the LED 1.

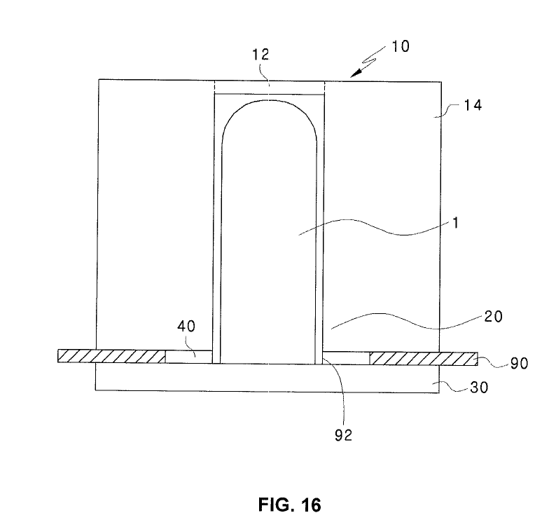

FIG. 16 is a schematic view of a third embodiment of the LED assembly with improved visibility and shapability according to the present invention. As shown in FIG. 16, the LED assembly according to a third embodiment of the present invention comprises an LED 1, a sidewall 40, a light-permeable part 10 and a fixing part 30. The third embodiment of the present invention is characterized by the sidewall 40.

The inside of the sidewall 40 comes in contact with the side of the LED 1, and the outside of the sidewall 40 comes in contact with the fixture 90. That is, the sidewall 40 is a part that comes in contact with the fixture 90 when the LED assembly according to the present invention is fixed to the fixture 90. Therefore, the diameter of the sidewall 40 is smaller than that of the light-permeable part 10 or fixing part 30.

The light-permeable part 10 is connected to the sidewall 40. The light-permeable part 10 is a part that surrounds the emission part of the LED 1 and transmits light of the LED 1 to the outside thereof. The light-permeable part 10 comprises at least one light-permeable thin part 12 and at least one light-permeable thick part 14.

The fixing part 30 is positioned beneath the LED 1, and may have a PCB substrate formed therein.

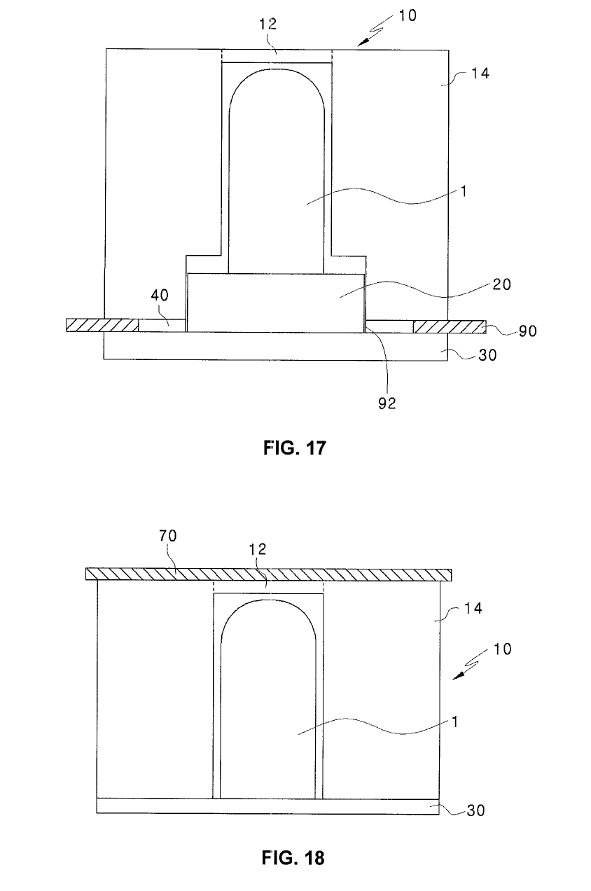

FIG. 17 is a schematic view of a fourth embodiment of the LED assembly with improved visibility and shapability according to the present invention. As shown in FIG. 17, the LED assembly according to the fourth embodiment of the present invention comprises an LED 1, a support platform 20, a sidewall 40, a light-permeable part 10 and a fixing part 30. The parts have been previously described above, and therefore, their detailed descriptions will be omitted.

Like the second embodiment, the light-permeable part 10 and the LED part may be separated from each other. A screw thread or hook may be formed so that the light-permeable part and the LED part are conveniently and firmly joined with each other in the process of inserting them into the insertion hole 92 of the fixture 90.

A reflection plate (not shown) may be mounted to the bottom surface of the light-permeable part 10 so that the visibility of the LED assembly is more emphasized by emitting forward light from the light-permeable part 10 and reducing the amount of light emitted to the sides of the light permeable part. In this case, most of the light is emitted in the emission direction of light from the light-permeable part 10 by the reflection plate.

FIG. 18 is a schematic view of a fifth embodiment of the LED assembly with improved visibility and shapability according to the present invention. The fifth embodiment of the present invention is characterized by the fact that an attachment part 70 is additionally formed. FIG. 18 is a schematic view of the LED assembly having an attachment part mounted therein as an example of the fifth embodiment. As shown in FIG. 18, the LED assembly according to the fifth embodiment of the present invention comprises an LED 1, a light-permeable part 10, a fixing part 30 and an attachment part 70. Only the attachment part 70 will be described. In the fifth embodiment, the attachment part 70 that is a top part of the LED assembly according to the present invention is attached to the fixture 90. The first to fourth embodiments may be basically applied to the LED assembly of the fifth embodiment except the attachment part 70. The fifth embodiment is different from the first to fourth embodiments in that the attachment part 70 is formed at the top part of the LED assembly so as to be attached to the fixture 90. The attachment part 70 has an area identical to or slightly wider than that of the light-permeable part so as to be attached to the fixture 90. The attachment part 70 is formed as thin a s possible within a range in which the attachment part does not interrupt the propagation of light. The attachment part 70 may be attached to the fixture using a high-frequency attaching method, or the like. In this embodiment, only a PCB substrate and a wire connected to the PCB substrate are included in the inside of the fixing part 30, but the fixing part is not attached to the fixture. Although it has been illustrated in FIG. 18 in that the attachment part 70 is further formed in the first embodiment, FIG. 18 may be applied to the second to fourth embodiments as it is.

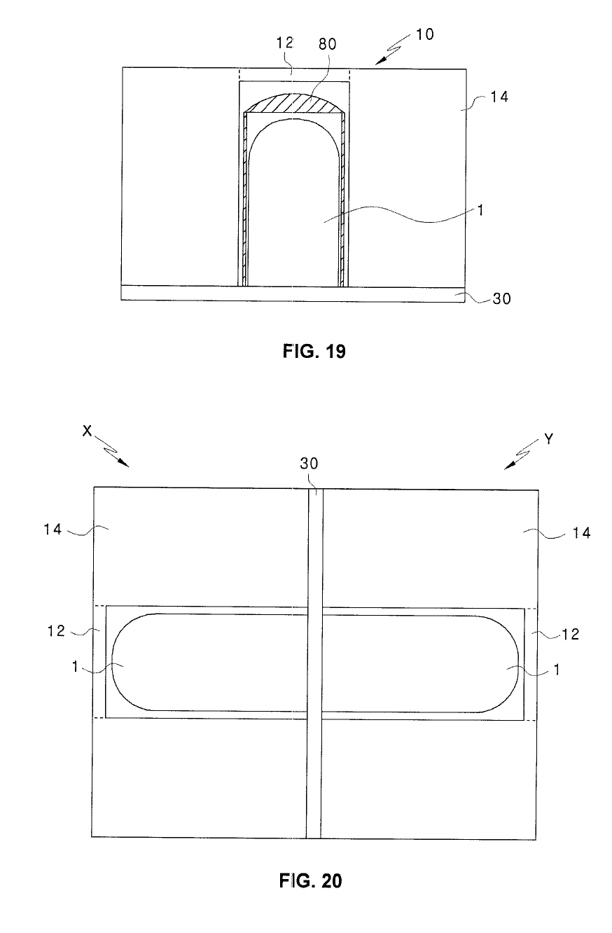

FIG. 19 is a schematic view of a sixth embodiment of the LED assembly with improved visibility and shapability according to the present invention. The sixth embodiment of the present invention is characterized by the fact that a light diffusion part is additionally formed. FIG. 19 is a schematic view of the LED assembly having a light diffusion part formed therein as an example of the sixth embodiment. As shown in FIG. 19, the LED assembly according to the sixth embodiment of the present invention comprises an LED 1, a light-permeable part 10, a fixing part 30 and a light diffusion part 80.

The light diffusion part 80 is a part for primarily diffusing light of the LED. The shape of the light diffusion part is not particularly limited, but the light diffusion part is preferably formed to surround the LED I. The bottom of the light diffusion part 80 is fixed to the fixing part. The light diffusion part forms a thin wall from the bottom of the fixing part 30 to the side of the LED, and has the shape of a convex lens formed at the top thereof. Light emitted from the LED 1 is primarily diffused by the light diffusion part 80 and then secondarily diffused by the light-permeable part 10 positioned at the outside of the light diffusion part 80. Unlike FIG. 19, the light diffusion part may be formed so that both sides of the light diffusion part are convex. Although it has been illustrated in FIG. 19 in that the light diffusion part 80 is further formed in the first embodiment, FIG. 19 may be applied to the second to fourth embodiments as it is.

FIG. 20 is a schematic view of a seventh embodiment of the LED assembly with improved visibility and shapability according to the present invention. In the seventh embodiment of the present invention, two LED assemblies of the first to sixth embodiments are joined with each other. The LED assembly according to the seventh embodiment of the present invention comprises two LEDs 1, two light-permeable parts 10 and a fixing part 30. Here, one light-permeable part and one LED are formed at each of the left and right sides about the fixing part 30. In FIG. 20, the left LED assembly X and the right LED assembly Y have the same rectangular shape, but the shapes of the left and right LED assemblies may be different from each other. For example, the left LED assembly X may have a hemispheric shape, and the right LED assembly Y may have a star shape.

The LED assembly of the seventh embodiment is used in a device capable of diffusing light from both sides thereof, and may be connected or fixed to the outside through the fixing part. Here, the connecting or fixing method is implemented using one known in the art, and therefore, its detailed description will be omitted.

A power supply means of the LED assembly according to the present invention is not particularly limited, and may be one as long as it operates the LED. For example, the power supply means may be a battery (condenser), AC power source, DC power source, solar cell, hybrid, or the like.

Although one LED has been described above, it will be apparent that a character or figure may be formed by combining several LEDs of the first to sixth embodiments. In this case, the character or figure formed by the combination of the LEDs can be easily recognized not only at a short distance but also at front and sides of the LED without the glare of intense light.

In this specification, the term ‘short distance’ is a concept including a just front side of the LED.

Hereinafter, a banner with improved visibility according to the present invention will be described.

The banner according to the present invention is manufactured by attaching LED assemblies to a conventional banner and employing a special light-permeable part in each of the LED assemblies. Thus, it is possible to more improve the visibility of the banner and to maximize the advertisement and public relations effects of the banner.

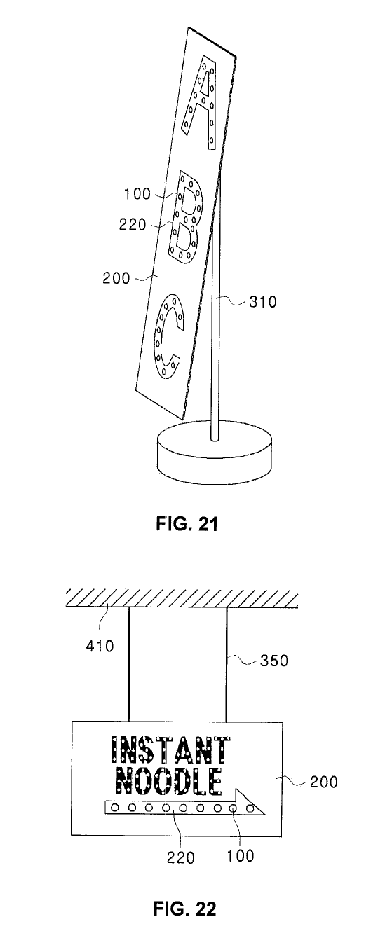

FIG. 21 is an exemplary view of a banner with improved visibility according to the present invention. As shown in FIG. 21, the banner with improved visibility according to the present invention comprises LED assemblies 100, a display part 200, a control part and a power supply part.

The display part 200 is a body part of the banner according the present invention. The display part is mainly made of a textile, sheet or the like. The display part 200 means one currently called as a banner in the street, and the shape of the display part is not particularly limited. As shown in FIG. 21, contents to be communicated are displayed as characters 220, numbers or figures in the display part 200, and the LED assemblies 100 are attached on the characters 220, numbers or figures. The material of the display part 200 is not particularly limited. However, the display part is preferably made of a material that can be restored even when the display part is rolled or crumpled. The display part 200 may further comprise a fixing means for fixing the banner. Here, the fixing means is not particularly limited. For example, the fixing means may be a rope, rod, cube, connection bar, or the like.

As shown in FIG. 21, the display part 200 may be formed by printing the characters 220 only on the front side thereof and attaching the LED assemblies 100 to the characters.

However, the display part 200 may be formed by joining two display parts together, printing the characters on each of both the sides of the joined display parts and then attaching the LED assemblies to the characters. In this case, electric wires formed at rear sides of the LED assemblies 100 are positioned between the joined display parts, so that the advertisement and public relations effects can be obtained from both sides of the banner.

As occasion demands, an auxiliary part may be attached to the rear side of the display part. Here, the auxiliary part is a film attached to the rear side of the display part so as to prevent the electric wires attached to the front side of the display part from being exposed to the outside of the rear side of the display part. The auxiliary part may be made of the same material as the display part. The auxiliary part may be attached to only a part to which the electric wire is exposed, or may cover the entire rear side of the display part. The auxiliary part may be subjected to waterproof processing, and accordingly, it is possible to solve an electrical problem caused in a rainy day when the auxiliary part is mounted outdoors. The combination of the display part and the auxiliary part may be implemented by a generally used method depending on a material. Specific examples of the display part 200 will be described in detail in the following embodiments.

The LED assemblies 100 are attached at a predetermined interval to the display part 200. The LED assembly 100 may simply use an LED, or may use an LED covered with a light-permeable part.

The banner according to the present invention preferably uses the LED assemblies each having the light-permeable parts so as to more improve the visibility of the banner.

The power supply part is a part that supplies power for emission and control of LEDs. The power supply part is not particularly limited. For example, the power supply part may be at least one of a battery, an AC power source, a DC power source, a solar cell and a hybrid. Particularly, since the banner ac cording to the present invention has a lower power consumption than the conventional banner, it is suitable to use the solar cell or hybrid as the power supply part. Since the control part and the power supply part are generally mounted at necessary parts, they are not separately shown in this figure.

Hereinafter, applications of the banner according to the present invention will be described based on detailed shapes of the banner.

### Embodiment 1

### Banner Mounted to Mounting Platform in Front of Shop

FIG. 21 is a schematic view of a banner mounted to a mounting platform as an embodiment of the banner according to the present invention. The banner is generally disposed in front of a shop in the street. A display part 200 is attached to a mounting platform 310, and characters 220 such as ‘ABC’ are printed in the display part 200. A plurality of LED assemblies 100 are attached along the characters 220. Although not shown in this figure, a control part and a power supply part separately exist.

Unlike the conventional simple banner, the LED assemblies are attached to the banner according to the present invention. Thus, it is possible to attract people's sight and to exactly inform the people of the contents of the banner. Since the LED assemblies are made of a transparent material, people can easily recognize the characters 220 printed in the banner event at daytime.

### Embodiment 2

### Banner for Displaying Position of Product Mounted to Ceiling in Shop

FIG. 22 is a schematic view of a banner for displaying the position of a product, mounted to an upper part of a shop, as an embodiment of the banner according to the present invention. Since various kinds of products are displayed in a large-scale mart, customers have difficulty in searching for the position of a product. Therefore, banners for indicating the positions of products are mounted to the ceiling in the large-scale mart. FIG. 22 is a schematic view of such a banner. As shown in FIG. 22, a display part 220 is hung by a string 350 connected to a ceiling 410. Characters ‘Instant Noodle’ and an arrow 220 are printed in the display part 200, and a plurality of LED assemblies 100 are attached along the characters and the arrow. Since the banner according to this embodiment easily attracts people's sight as compared with general banners, the banner can be used to attract customers' sight for a product necessary for advertisement.

### Embodiment 3

### Entrance Banner

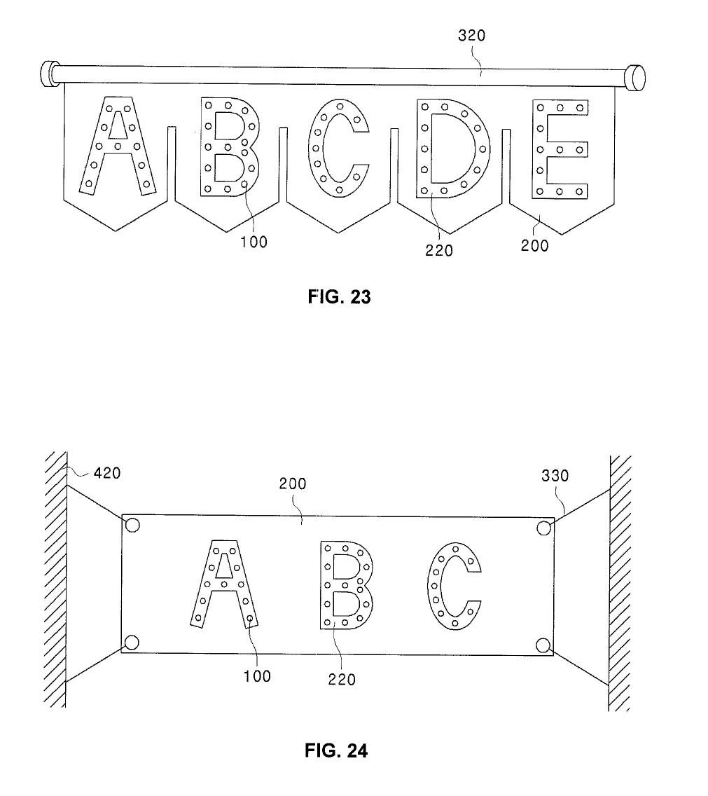

FIG. 23 is a schematic view of a banner mounted at an entrance of a shop as an embodiment of the banner according to the present invention. The banner according to this embodiment has a configuration in which a rope or rod is disposed at an entrance of a shop, and the banner is hung on the rope or rode, which is referred to as ‘Doran’ in Japan. As shown in FIG. 23, a lateral display part 200 is hung on a rod 320, and characters 220 ‘ABODE’ are printed in the display part 200. A plurality of LED assemblies are attached in the inside the characters 220.

### Embodiment 4

### Streetlight Banner

A streetlight banner, as an embodiment of the banner according to the present invention, is a banner mounted to a streetlight, traffic light, tree or the like. The banner can be frequently seen in a large city. A connection bar is connected to a street light, and a display part is attached to the connection bar. Characters are printed in the display part, and a plurality of LED assemblies are attached in the inside of the characters. The streetlight banner may have a separate fixing means formed at a lower part of the banner as occasion demands.

### Embodiment 5

### Placard Banner

FIG. 24 is a schematic view of a placard banner as an embodiment of the banner according to the present invention. The banner according to this embodiment is generally referred to as a placard. The banner includes all placards from a large-sized placard mounted on the street to a small-sized placard mounted in a shop. As shown in FIG. 24, a display part 200 is connected by fixing ropes 330 connected to telegraph posts 420, and characters 220 ‘ABC’ are printed in the display part 200. A plurality of LED assemblies 100 are attached in the inside of the characters 220.

### Embodiment 6

### Window Banner

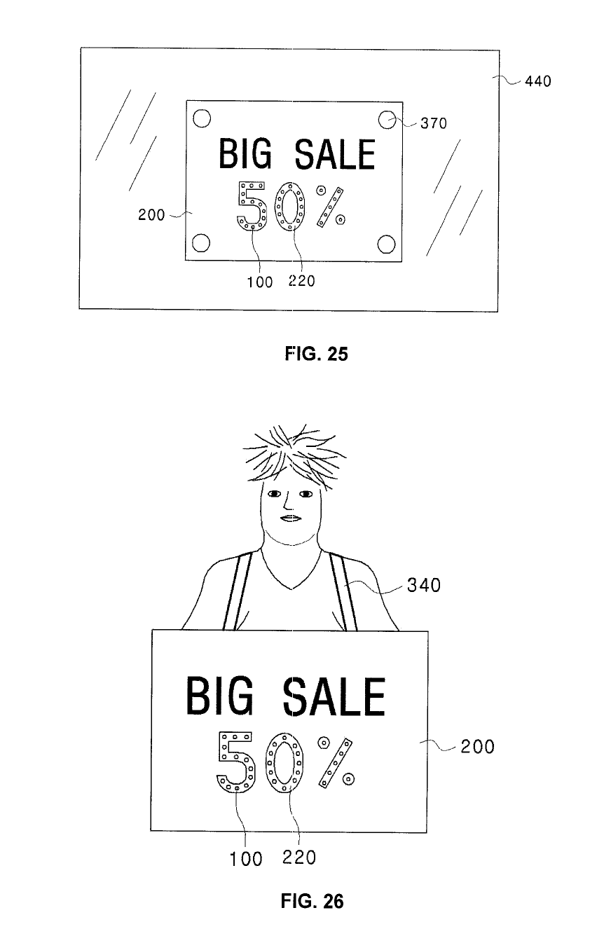

FIG. 25 is a schematic view of a banner mounted to window as an embodiment of the banner according to the present invention. The banner according to this embodiment means a small-sized banner mounted to the inside/outside of window in a shop. As shown in FIG. 25, a display part 200 is attached to window by cubes 370. Charters ‘50%’ are printed in the display part 200, and a plurality of LED assemblies 100 are attached in the inside of the characters 220.

### Embodiment 7

### Banner Using Person

FIG. 26 is a schematic view of a banner using a person as an embodiment of the banner according to the present invention. The banner according to this embodiment is a banner with an expression, which is held or worn by a person on the street. As shown in FIG. 26, display parts 200 are respectively hung at the front and rear of a person by shoulder straps 340, and characters 220 ‘50%’ are printed in each of the display parts 200. A plurality of LED assemblies 100 are attached in the inside of the characters 220.

In addition to the aforementioned embodiments, the banner with improved visibility according to the present invention can be applied to various types of banners.

### INDUSTRIAL APPLICABILITY

The LED assembly with improved visibility and shapability according to the present invention can be used in all fields to which the LED assembly is applicable by improving the visibility and shapability at long and short distances. As a representative example, the LED assembly can be applied to signboards, banners, various kinds of signs, carpets, bags, umbrellas, raincoats, armbands, safety helmets, and the like.

Although the present invention has been described in detail in connection with the specific embodiments, it will be readily understood by those skilled in the art that various modifications and changes can be made thereto within the technical spirit and scope of the present invention. It is also apparent that the modifications and changes fall within the scope of the present invention defined by the appended claims.

1. An LED assembly with improved visibility and shapability, the LED assembly comprising: at least one LED; a light-permeable part configured to surround an emission part of the LED, transmit light of the LED to an outside thereof, and have a flat bottom surface; and a fixing part positioned on a bottom surface of the LED, wherein the light-permeable part comprises at least one light-permeable thin part of which thickness is thin in the light-permeable part so as to ease the glare of intense light just in front of the LED and to improve visibility at a long distance, and at least one light-permeable thick part of which thickness is thicker than that of the light-permeable thin part in the light permeable part so as to emit the light to sides of the LED by widely diffusing the light of the LED.

2. The LED assembly of claim 1, wherein the light-permeable thin or thick part may have the shape of a figure, number or character.

3. The LED assembly of claim 1, wherein a barrier for surrounding the LED may be mounted to the fixing part, and the light-permeable part may be joined with the barrier.

4. The LED assembly of claim 1, wherein the light-permeable part and the LED may be separated from each other.

5. (canceled)

6. The LED assembly of claim 1, wherein the light-permeable thin part may have a thickness of 0.1 to 10 mm, and the light-permeable thick part may have a thickness 1.5 to 20 times thicker than the thickness of the light-permeable part.

7. The LED assembly of claim 1, further comprising a support platform positioned on a bottom surface of the LED.

8. (canceled)

9. The LED assembly of claim 1, further comprising a sidewall of which inside and outside come in contact with sides of the LED and a fixture, respectively.

10. The LED assembly of claim 1, further comprising a support platform positioned on a bottom surface of the LED; and a sidewall of which inside and outside come in contact with sides of the LED and a fixture, respectively.

11. (canceled)

12. An LED assembly with improved visibility and shapability, the LED assembly comprising: two LEDs respectively attached to both sides of a fixing part about the fixing part; and two light-permeable parts configured to surround the respective LEDs, transmit light of the respective LEDs to outsides thereof, and each have a flat bottom surface, wherein each of the light-permeable part comprises at least one light-permeable thin part of which thickness is thin in the light-permeable part so as to ease the glare of intense light just in front of the LED and to improve visibility at a long distance, and at least one light-permeable thick part of which thickness is thicker than that of the light-permeable thin part in the light permeable part so as to emit the light to sides of the LED by widely diffusing the light of the LED.

13. An LED assembly with improved visibility and shapability, the LED assembly comprising a plurality of LED assemblies configured to represent a character or figure through a combination thereof, wherein each of the LED assemblies comprises at least one LED; a light-permeable part configured to surround an emission part of the LED, transmit light of the LED to an outside thereof, and have a flat bottom surface; and a fixing part positioned on a bottom surface of the LED, wherein the light-permeable part comprises at least one light-permeable thin part of which thickness is thin in the light-permeable part so as to ease the glare of intense light just in front of the LED and to improve visibility at a long distance, and at least one light-permeable thick part of which thickness is thicker than that of the light-permeable thin part m the light permeable part so as to emit the light to sides of the LED by widely diffusing the light of the LED.

14. The LED assembly of claim 1, further comprising a light diffusion part formed around the LED for widely diffusing light so that the light-permeable thick part can be more enlightened at its flat bottom surface.

15. The LED assembly of claim 7, wherein at least one groove or embossing is formed at the part which the inside of the light-permeable part comes in contact with the LED.

16. (canceled)

17. (canceled)

18. (canceled)

19. A banner using LED assemblies with improved visibility and shapability, the banner comprising: a display part in which contents intended to communicate are displayed; a plurality of LED assemblies of claim 1 attached at a predetermined interval in the display part; a control part configured to control the LED assemblies; and a power supply part configured to supply power to the LED assemblies.

20. The banner of claim 19, wherein the display part may be made of a material restorable even when the display part is rolled or crumpled.

21. The banner of claim 19, wherein the display part may be formed by joining two display parts together so that contents intended to communicate by the two display parts face outsides opposite to each other.

22. The banner of claim 19, further comprising an auxiliary part for surrounding electric wires of the LED assemblies attached to a rear side of the display part.

23. (canceled)
